(19) United States
(12) Patent Application Publication
(10) Pub. No.: US 2025/0012767 A1
(43) Pub. Date: Jan. 9, 2025

(54) Chromatograph Mass Spectrometer and Chromatograph Mass Spectrometry Data Processing Method

(71) Applicant: SHIMADZU CORPORATION

(72) Inventor: Kazuma MAEDA, Kyoto-shi (JP)

(21) Appl. No.: 18/691,492

(22) PCT Filed: Feb. 4, 2022
(86) PCT No.: PCT/JP2022/004441

§ 371 Date: Mar. 13, 2024

(30) Foreign Application Priority Data
Oct. 14, 2021 (WO) PCT/JP2021/038069

(51) Int. Cl. G01N 30/86; G01N 30/72

(52) U.S. Cl. CPC G01N 30/8631; G01N 30/7206

(57) ABSTRACT

A chromatograph mass spectrometer includes a data processing unit to process data collected by chromatograph mass spectrometry, the data processing unit including: first peak detection units to generate a chromatogram reflecting signal intensities at a m/z on the basis of the collected data and perform peak detection on the chromatogram; an EIC creation unit to create an EIC for m/z of a centroid peak observed in a mass spectrum obtained in a time range of the peak for at least one of the detected peaks; a second peak detection unit to perform peak detection on the created EIC and obtain a retention time of a peak top of the detected peak; a grouping unit to classify peak tops into groups having substantially the same retention time; and a selection unit to select one or more m/zs or EICs corresponding to m/zs as a representative for each group.

### TECHNICAL FIELD

The present invention relates to a liquid chromatograph mass spectrometer, a chromatograph mass spectrometer including a gas chromatograph mass spectrometer, and a chromatograph mass spectrometry data processing method.

### BACKGROUND ART

In recent years, chromatograph mass spectrometers such as a liquid chromatograph mass spectrometer (LC-MS) and a gas chromatograph mass spectrometer (GC-MS) have been widely used for comprehensively analyzing a large number of compounds contained in a sample. In general, when quantitative analysis is performed using a chromatograph mass spectrometer, an extracted ion chromatogram (EIC) showing the relationship between ionic intensity and retention time of a mass-to-charge ratio (it is referred to as “mass-to-charge ratio” or “m/z” in the present specification) corresponding to a target compound to be quantified is created, and a quantitative value is calculated by comparing a calibration curve with the area or height of a peak appearing in the chromatogram.

In the case of quantifying only a predetermined target compound, when a user specifies an m/z value corresponding to the target compound, an EIC at the specified m/z value is created. However, there is a possibility that a peak derived from another compound having the same (or very close) m/z value as that of the target compound overlaps with the peak of the EIC thus obtained, or the peak itself may not be the target compound but the peak derived from another compound. As a technique for discriminating a peak affected by such contaminants or the like, for example, there is a method described in Patent Literature 1.

In the method described in the literature, EICs for a plurality of m/z values determined for each target compound are made. Peaks are detected in the EICs, and the peaks are grouped on the basis of the retention times of the peaks. Then, the presence or absence of the target compound or the presence of contaminants is determined using the actually measured mass spectrum obtained at the retention time of a peak top of one peak included in each group and a standard mass spectrum of the target compound. However, the conventional method is based on the premise that a target compound having a known m/z value is quantified, and is not suitable for quantification of an unknown compound contained in a sample.

### CITATION LIST

### Patent Literature

Patent Literature 1: JP 2016-095253 A

### SUMMARY OF INVENTION

### Technical Problem

In order to comprehensively analyze compounds contained in a sample as described above, it is necessary to quantify not only known target compounds contained in the sample but also unknown compounds. For this purpose, it is preferable to obtain EICs corresponding to various compounds contained in the sample regardless of whether the compound is known or unknown. On the other hand, in the data collected by chromatograph mass spectrometry, ionic intensity derived from impurities or the like contained, for example, in the mobile phase also appears. EICs corresponding to such a substance not to be analyzed is unnecessary.

In order to obtain an EIC corresponding to a compound to be analyzed by a user, it is generally necessary for the user to observe a mass spectrum and then specify an m/z value for creating the EIC. However, since the amount of data collected by chromatograph mass spectrometry is enormous, such work by the user is very complicated and time-consuming, and inefficient. In addition, since such work greatly depends on the skill, experience, and the like of the operator in charge of the work, it is inevitable that variations occur in results, and omission of extraction of compounds and work errors are likely to occur.

The present invention has been made to solve such problems, and a main object of the present invention is to provide a chromatograph mass spectrometer and a chromatograph mass spectrometry data processing method for extracting an EIC corresponding to a target compound or an unknown compound in a sample as completely as possible from data collected by chromatograph mass spectrometry without complicated work by a user.

### Solution to Problem

One mode of the chromatograph mass spectrometer according to the present invention made to solve the above problems is a chromatograph mass spectrometer including a data processing unit configured to process data collected by chromatograph mass spectrometry, the data processing unit including:
a first peak detection unit configured to create a chromatogram reflecting signal intensity at a plurality of mass-to-charge ratios on the basis of the collected data and perform peak detection on the chromatogram;
an extracted ion chromatogram creation unit configured to create, for at least one of peaks detected by the first peak detection unit, an extracted ion chromatogram with respect to a mass-to-charge ratio of a centroid peak observed in a mass spectrum obtained in a time range of the at least one of peaks;
a second peak detection unit configured to perform peak detection on the extracted ion chromatogram created by the extracted ion chromatogram creation unit, and to obtain a retention time of a peak top of the detected peak;
a grouping unit configured to classify the peaks detected by the second peak detection unit into groups having substantially the same retention time of the peak top; and
a selection unit configured to select one or more representative mass-to-charge ratios or one or more extracted ion chromatograms corresponding to representative mass-to-charge ratios for each group classified by the grouping unit.

In addition, one mode of the chromatograph mass spectrometry data processing method according to the present invention made to solve the above problems is a chromatograph mass spectrometry data processing method for processing data collected by chromatograph mass spectrometry, the method including:
a first peak detection step of creating a chromatogram reflecting signal intensity at a plurality of mass-to-charge ratios on the basis of the collected data and perform peak detection on the chromatogram;
an extracted ion chromatogram creation step of creating, for at least one of peaks detected in the first peak detection step, an extracted ion chromatogram with respect to a mass-to-charge ratio of a centroid peak observed in a mass spectrum obtained in a time range of the at least one of peaks;
a second peak detection step of performing peak detection on the extracted ion chromatogram created in the extracted ion chromatogram creation step, and obtaining a retention time of a peak top of the detected peak;
a grouping step of classifying the peaks detected in the second peak detection step into groups having substantially the same retention time of the peak top; and
a selection step of selecting one or more representative mass-to-charge ratios or one or more created ion chromatograms corresponding to representative mass-to-charge ratios for each group classified in the grouping step.

### Advantageous Effects of Invention

According to the above modes of the chromatograph mass spectrometer and the chromatograph mass spectrometry data processing method according to the present invention, it is possible to extract EICs corresponding to target compounds and unknown impurities and contaminants in a sample without omission from an enormous amount of mass spectrum data and chromatogram data collected by chromatograph mass spectrometry without complicated work and operation by a user (operator). By automatically performing such processing, the burden on the operator can be reduced. In addition, since such processing does not depend on the skill, experience, and the like of the operator, variations in processing results can be suppressed. In addition, the time required for the operation can be shortened, and the compound can be efficiently analyzed.

### BRIEF DESCRIPTION OF DRAWINGS

FIG. 1 is a configuration diagram of a main part of an LC-MS that is an embodiment of a chromatograph mass spectrometer according to the present invention.

FIG. 2 is a flowchart illustrating a flow of EIC automatic extraction processing in the LC-MS of the present embodiment.

FIG. 3 is a diagram illustrating an example of peaks whose retention times are close to each other.

FIG. 4 is an explanatory diagram of processing of grouping EICs in which peaks illustrated in FIG. 3 are observed.

FIG. 5 is a diagram illustrating a result of grouping of EICs in which the peaks illustrated in FIG. 3 are observed.

FIGS. 6A to 6D are conceptual diagrams of the EIC automatic extraction processing in the LC-MS of the present embodiment.

FIG. 7 is a diagram illustrating an example of a display form of an EIC automatically extracted in the LC-MS of the present embodiment.

FIG. 8 is a diagram illustrating another example of the display form of the EIC automatically extracted in the LC-MS of the present embodiment.

FIGS. 9A to 9D are explanatory diagrams of mass spectrum separation processing in the LC-MS of the present embodiment.

FIG. 10 is a diagram illustrating an example of a mass spectrum obtained by binarizing intensity values.

FIG. 11 is a Venn diagram illustrating an example of a relationship between sets of mass peaks obtained by the mass spectrum separation processing in the LC-MS of the present embodiment.

FIG. 12 is a Venn diagram illustrating another example of a relationship between sets of mass peaks obtained by the mass spectrum separation processing in the LC-MS of the present embodiment.

FIG. 13 is a Venn diagram illustrating another example of a relationship between sets of mass peaks obtained by the mass spectrum separation processing in the LC-MS of the present embodiment.

FIG. 14 is a Venn diagram illustrating another example of a relationship between sets of mass peaks obtained by the mass spectrum separation processing in the LC-MS of the present embodiment.

### DESCRIPTION OF EMBODIMENTS

Hereinafter, an LC-MS according to an embodiment of the present invention will be described with reference to the accompanying drawings.

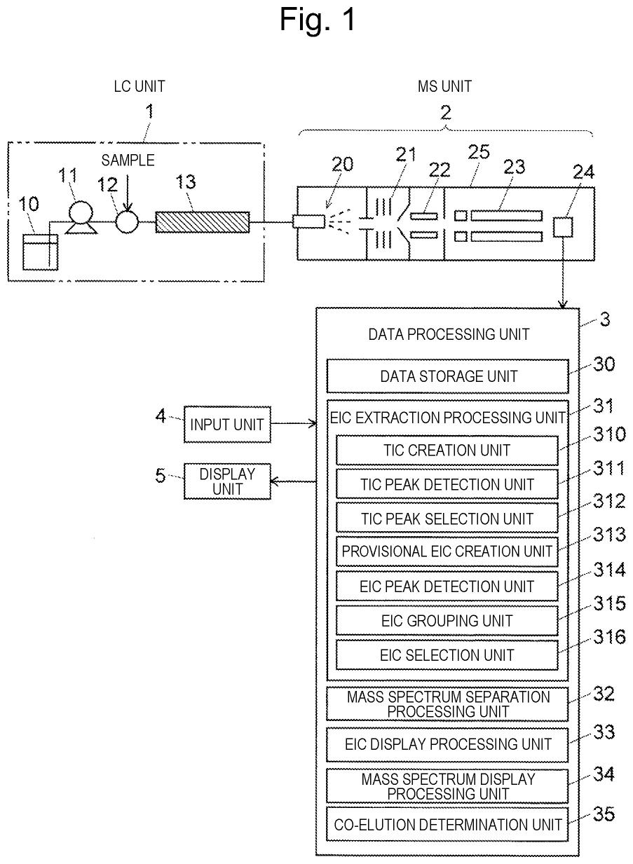

FIG. 1 is a configuration diagram of a main part of an LC-MS of the present embodiment. The LC-MS of the present embodiment includes a liquid chromatograph unit (LC unit) 1 and a mass spectrometry unit (MS unit) 2 as measurement units, a data processing unit 3, an input unit 4, and a display unit 5. Note that, in FIG. 1, description of a control unit that controls the LC unit 1 and the MS unit 2 for LC/MS analysis is omitted.

The LC unit 1 includes a mobile phase container 10 in which a mobile phase is stored, a liquid feeding pump 11 that draws the mobile phase and delivers the mobile phase at a fixed flow rate, an injector 12 that injects a sample into the mobile phase at a predetermined timing, a column 13 that separates various compounds in the sample in a time direction, and the like.

The MS unit 2 is a single type quadrupole mass spectrometer, and includes an ionization unit 20 that ionizes a compound contained in an eluate from the column 13, ion guides 21 and 22 that transport generated ions, a quadrupole mass filter 23 that selectively passes ions having a specific m/z, a detector 24 that detects ions, and the like. Note that the MS unit 2 is not limited to the single type quadrupole mass spectrometer, and other types of mass spectrometers such as a triple quadrupole mass spectrometer and a quadrupole-time-of-flight mass spectrometer can also be used.

The data processing unit 3 that receives a detection signal from the detector 24 of the MS unit 2 includes, as functional blocks, a data storage unit 30, an EIC extraction processing unit 31, a mass spectrum separation processing unit 32, an EIC display processing unit 33, a mass spectrum display processing unit 34, and a co-elution determination unit 35. The EIC extraction processing unit 31 includes, as lower functional blocks, a TIC creation unit 310, a TIC peak detection unit 311, a TIC peak selection unit 312, a provisional EIC creation unit 313, an EIC peak detection unit 314, an EIC grouping unit 315, and an EIC selection unit 316.

In general, the data processing unit 3 and the control unit (not illustrated) are configured such that a personal computer including a CPU, a memory, and the like or a computer having higher performance called a workstation is used as hardware, and by executing dedicated processing and control software (computer program) installed in advance in the computer on the computer, at least a part of functions of the computer program is realized. In this case, the input unit 4 is a pointing device such as a keyboard or a mouse attached to the computer, and the display unit 5 is a display monitor attached to the computer.

The above-described computer program can be provided to a user by being stored in a non-transitory computer-readable recording medium such as a CD-ROM, a DVD-ROM, a memory card, or a USB memory (dongle). In addition, the program can be provided to the user in the form of data transfer via a communication line such as the Internet. Furthermore, the program can be pre-installed in a computer which is a part of the system (strictly, a storage device which is a part of the computer) when the user purchases the system.

First, the LC/MS analysis operation executed by the LC unit 1 and the MS unit 2 in the LC-MS of the present embodiment will be briefly described. This LC/MS analysis operation is the same as that performed in general LC-MS.

In the LC unit 1, the liquid feeding pump 11 draws the mobile phase from the mobile phase container 10 and feeds the mobile phase to the column 13 at a fixed flow rate. The injector 12 injects a sample into the mobile phase at a predetermined timing. The injected sample is introduced into the column 13 along the flow of the mobile phase. Various compounds in the sample are separated in the time direction by interaction with a liquid phase of the column 13 while passing through the column 13, and are eluted from an outlet of the column 13 in a temporally shifted manner.

The compounds in the eluate from the column 13 are ionized in the ionization unit 20, and the ions generated in the ionization unit 20 are transported by the ion guides 21 and 22 and introduced into the quadrupole mass filter 23. At the time of simultaneous analysis of compounds including unknown compounds in a sample, the quadrupole mass filter 23 is driven so as to repeat scan measurement in a predetermined m/z range. The detector 24 outputs, as a detection signal, an ionic intensity corresponding to the amount of ions that can pass through the quadrupole mass filter 23 driven in this manner. Therefore, the detection signal corresponding to the mass spectrum in the predetermined m/z range is repeatedly input to the data processing unit 3 until the predetermined analysis time elapses from the time point at which the sample is injected into the mobile phase in the LC unit 1.

In the data processing unit 3, the data storage unit 30 includes an analog-to-digital conversion unit, and digitizes and stores detection signals sequentially input as time passes. Therefore, a large amount of data constituting each of the mass spectrum and the chromatogram is stored in the data storage unit 30.

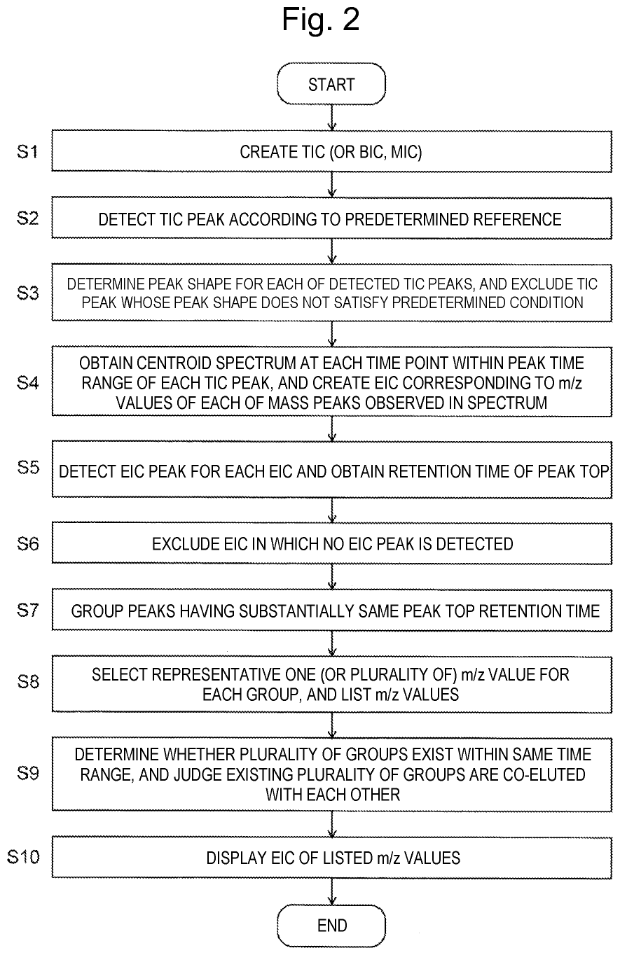

Next, an example of characteristic data processing performed using data collected by performing LC/MS analysis on a certain sample in a state where the data is stored will be described with reference to FIG. 2 to FIGS. 6A to 6D. FIG. 2 is a flowchart illustrating a flow of EIC automatic extraction processing performed in the data processing unit 3.

For example, when the user performs a predetermined operation on the input unit 4, the EIC extraction processing unit 31 starts the EIC automatic extraction processing. First, the TIC creation unit 310 creates a total ion chromatogram (TIC) on the basis of the data read from the data storage unit 30 (step S1).

This chromatogram is not a chromatogram corresponding to one specific m/z value, but may be a chromatogram reflecting peaks observed at various m/z values. Therefore, instead of the TIC, a base peak chromatogram (BPC) or a multi ion chromatogram (MIC) may be used. The MIC is a chromatogram obtained by adding up ionic intensities in an m/z range excluding one or more specific m/z values or m/z ranges in the entire measurement m/z range.

Note that the EIC is not necessarily a chromatogram originally showing a temporal change in ionic intensity with respect to one m/z value, and includes a chromatogram showing a temporal change in a total value of ionic intensities with respect to a plurality of m/z values, and thus may include the MIC. However, in the present specification, EIC refers to a chromatogram showing a temporal change in ionic intensity with respect to a specific m/z value, and is distinguished from the MIC.

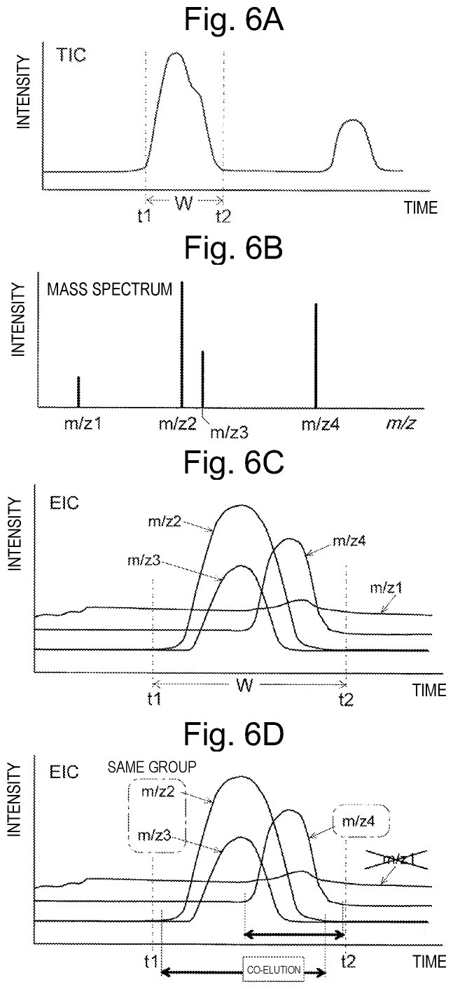

The TIC peak detection unit 311 executes peak detection on one TIC created by the TIC creation unit 310 according to a predetermined reference, and obtains time of a peak start point and an end point for each detected peak (step S2). FIG. 6A illustrates an example of the TIC. When peak detection is performed on the TIC, two peaks are detected. The start point and end point of the first peak are t1 and t2, and a time range t1 to t2 is a peak range W of this peak.

Subsequently, the TIC peak selection unit 312 determines whether the peak shape satisfies a predetermined condition set in advance for each of all the TIC peaks detected by the TIC peak detection unit 311, and excludes a TIC peak that does not satisfy the predetermined condition (step S3).

The main purpose of this step is, for example, to exclude a noise peak derived from the mobile phase or the like as much as possible, and a predetermined condition may be determined so as to meet such a purpose. As an example, it is possible to set a predetermined condition that the inclination of the tangent of the first half (rising) and/or the second half (falling) of the peak satisfies a reference. In addition, as another example, a coefficient of variation (relative variation) for the intensity value of each point constituting the TIC peak is calculated, and it is possible to set a predetermined condition that the coefficient of variation satisfies the reference. The coefficient of variation is usually a value obtained by standard deviation/average.

Note that by adding the predetermined condition in step S3 to the condition for detecting the TIC peak in step S2, steps S2 and S3 can be executed substantially simultaneously.

Thereafter, the provisional EIC creation unit 313 obtains data constituting a large number of mass spectra obtained at each time point between the peak ranges (start point to end point) for each TIC peak remaining by the selection in step S3, and performs centroid conversion for each mass spectrum to calculate a centroid spectrum. At the time of centroid, for example, a kind of noise removal processing such as excluding a mass peak whose signal intensity is equal to or less than a threshold value may be performed. Then, m/z values of mass peaks observed in all centroid spectra included in the entire peak range are obtained, and an EIC for the m/z values is created (step S4). This EIC may be the entire measurement range or only the peak range of the original TIC peak.

Note that, between the plurality of centroid spectra obtained at each time point within the peak range, it is inevitable that an m/z shift due to a limit such as the mass accuracy of the MS unit 2 occurs in the mass peak having theoretically the same m/z value. Therefore, an allowable width of the m/z deviation may be determined in advance, and the m/z value may be determined by estimating that mass peaks included in the allowable width have the same m/z value. As a result, it is possible to avoid a situation in which a plurality of EICs corresponding to the same ion are created due to the restriction of the performance of the MS unit 2.

For example, a centroid spectrum obtained at a certain time point in the peak range W of the first TIC peak in FIG. 6A is illustrated in FIG. 6B, and mass peaks other than the mass peak in the centroid spectrum do not exist in the peak range W. In that case, EICs for four m/z values with m/z values of m/z1, m/z2, m/z3, and m/z4, respectively, are created. This EIC is shown in FIG. 6C. Note that, in FIG. 6C, the EIC outside the peak range W is also depicted. In this way, one or more EICs can be created for each TIC peak.

The EIC peak detection unit 314 executes peak detection for each EIC according to a predetermined reference, and obtains a retention time of a peak top of the detected EIC peak (step S5). At this time, the EIC peak detection unit 314 excludes EIC in which no peak is detected (step S6).

In FIG. 6C, the EIC of m/z1 is an EIC corresponding to a compound (for example, impurities mixed in the mobile phase) contained in the mobile phase. Such a compound that appears over the entire measurement time shows a mass peak in the centroid spectrum as shown in FIG. 6B, but since the intensity change in the time direction is small, a clear peak does not appear in the EIC. Therefore, such EIC is excluded in the processing of step S6.

Next, the EIC grouping unit 315 groups the EIC peaks detected by the EIC peak detection unit 314 for each peak having substantially the same retention time of the peak top (that is, in a time range that can be regarded as the same) (step S7). The time range that can be regarded as the same group may be constant regardless of the retention time, but for example, the larger the retention time of the peak, the wider the time range.

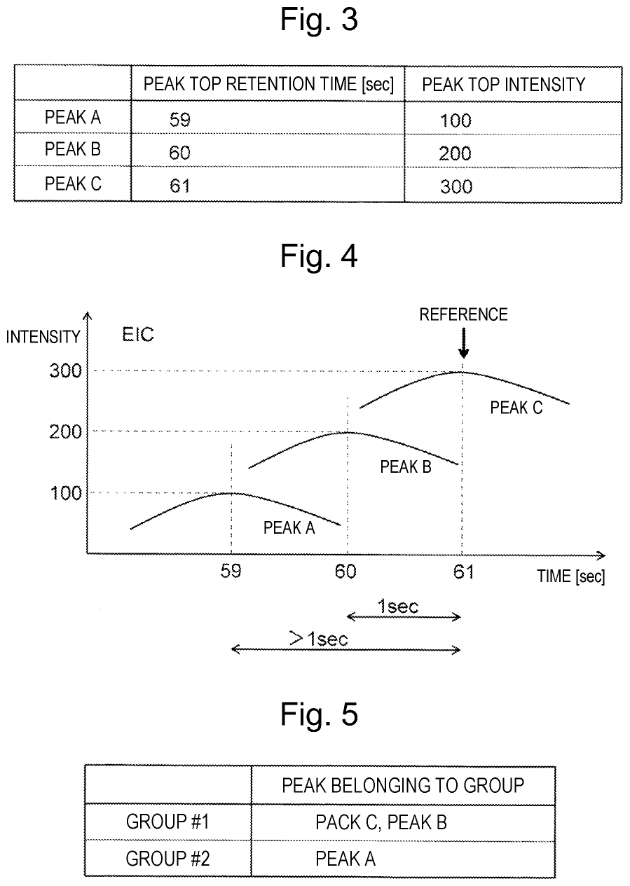

Here, an example of a rule for grouping EIC peaks will be described with reference to FIGS. 3 to 5.

In this example, when a plurality of EIC peaks present in the same peak range are grouped, priority is given to the intensity of the peak top, and groups are formed in order of highest intensity. Then, the already grouped EIC peaks do not belong to other groups.

Now, it is assumed that three EIC peaks A, B, and C with retention time and intensity as shown in FIG. 3 exist in the peak range of one TIC peak. In addition, the time range in which the retention times of the peak tops can be regarded as the same is assumed to be within 1 second. FIG. 4 is a schematic diagram of chromatogram waveforms near the three EIC peaks A, B, and C illustrated in FIG. 3.

As described above, since the grouping is performed with priority given to the intensity of the peak top here, the EIC grouping unit 315 selects the EIC peak C having the highest intensity and determines it as a reference. With respect to the retention time (61 seconds) of the EIC peak C, the retention time (60 seconds) of the peak top of the EIC peak B having the second highest intensity is within 1 second. Therefore, the EIC grouping unit 315 classifies the EIC peak C and the EIC peak B into the same group. Next, when the retention time (61 seconds) of the peak top of the EIC peak A having the second highest intensity after the EIC peak B with respect to the retention time (59 seconds) of the EIC peak C is confirmed, the difference exceeds 1 second. Therefore, the EIC grouping unit 315 classifies the EIC peak A into a group different from the EIC peaks C and B. Therefore, in this example, as a result of grouping the EIC peaks, two groups #1 and #2 are formed as illustrated in FIG. 5.

When peak detection is performed for the three EICs illustrated in FIG. 6C (as described above, the EIC of m/z1 is excluded) and the detected peaks are grouped, as illustrated in FIG. 6D, the peak of m/z2 and the peak of m/z3 are classified into the same group, and the peak of m/z4 is classified into another group. That is, in this example, it can be judged that two groups exist in the time range t1 to t2 of the peak range W of one TIC peak.

Ions exhibiting m/z values belonging to the same group can be estimated to be different ions derived from the same compound. This is, for example, an isotopic ion having exactly the same chemical structure and different isotopes of constituent elements, or an adduct ion in which an ion of a certain compound and another molecule (adduct) are added at the time of ionization of the ion. In addition, the ion may be a polyvalent ion derived from the same compound and having different valences, or may be multimer ions in which polymerization has occurred during ionization. Such ions should be classified into the same group since basically the retention time is the same and only the m/z value is different. On the other hand, although the EIC peak at m/z4 in FIG. 6D is present within the peak range W of one TIC peak, the retention time of the EIC peak is clearly different from the retention times of the EIC peaks at m/z2 and m/z3, and it can be estimated that the EIC peak is not an ion derived from the same compound as those of the EIC peaks at m/z2 and m/z3. In this way, a plurality of overlapping peaks in the TIC peak can be separated into chromatographic peaks corresponding to the respective compounds.

After the grouping of the EIC peaks as described above for each TIC peak is completed, the EIC selection unit 316 selects one m/z value for each group. It may be configured such that a plurality of m/z values can be selected instead of one, but usually one is sufficient. Typically, the m/z value at which the intensity of the peak top is maximum may be selected, but the selection method is not limited to this. The EIC selection unit 316 lists the m/z values selected for each group (step S8). As a result, the automatic extraction of the EIC from the original TIC (actually, the extraction of the m/z value corresponding to the EIC) ends.

The co-elution determination unit 35 determines whether or not a plurality of groups exist in the peak range of one TIC peak on the basis of the result of the grouping. If there are a plurality of groups, it is determined that the plurality of groups are co-eluted with each other (step S9). In the example of FIG. 6D, it can be judged that the group including the compounds whose m/z values are m/z2 and m/z3 and the group including the compound whose m/z value is m/z4 are co-eluted with each other.

The EIC display processing unit 33 draws EICs corresponding to the respective m/z values listed in the EIC selection unit 316 and displays the drawn EICs on the display unit 5 (step S10). Usually, a large number of EICs are obtained, but they may be superimposed and drawn with different display colors, or may be stacked and displayed little by little in the vertical direction. Alternatively, a large number of EICs may be switchably displayed by a tab or the like. In addition, at this time, as illustrated in FIG. 6C, ETC over a wide time range (at the maximum, the entire measurement time range) including each EIC peak may be displayed, or a waveform of only a peak portion of the EIC peak, that is, a range from a start point to an end point of the peak, or a predetermined narrow time range including the peak portion may be extracted and displayed for each ETC.

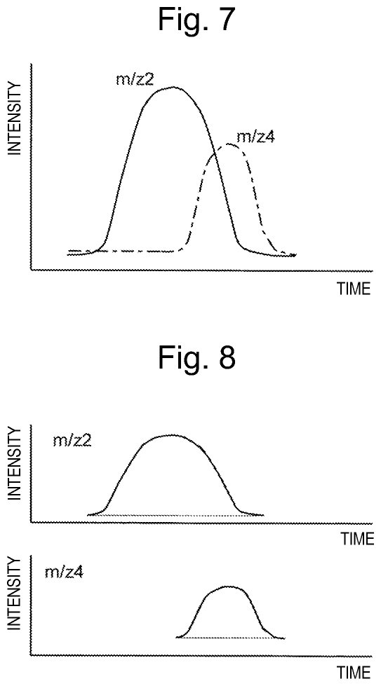

FIG. 7 illustrates an example in which only waveforms in a time range around the peak portions of the two EIC peaks extracted in the example of FIGS. 6A to 6D are extracted and displayed in an overlapping manner. FIG. 8 illustrates an example in which only peak portions of the two EIC peaks are extracted and displayed vertically side by side. By displaying only the EIC peak portion in this manner, the user can easily grasp the waveform of the chromatographic peak corresponding to the compound.

In addition, when the EIC is displayed as described above, the determination result regarding co-elution may be displayed together. For example, a display mode in which a curve showing a waveform in a time range in which co-elution occurs at each EIC peak is displayed in a color different from other time ranges, or a background portion in a time range in which co-elution occurs is displayed in a color different from the other time ranges is considered. In addition, it is preferable that such a display mode of the EIC can be switched according to the setting by the user.

Furthermore, in the LC-MS of the present embodiment, it is possible to obtain mass spectrum information such as, for example, a mass spectrum mainly reflecting each compound or a mass spectrum excluding a mass peak derived from a specific compound from a mass spectrum in which mass peaks derived from a plurality of compounds are mixed using the separation result of the ETC peak.

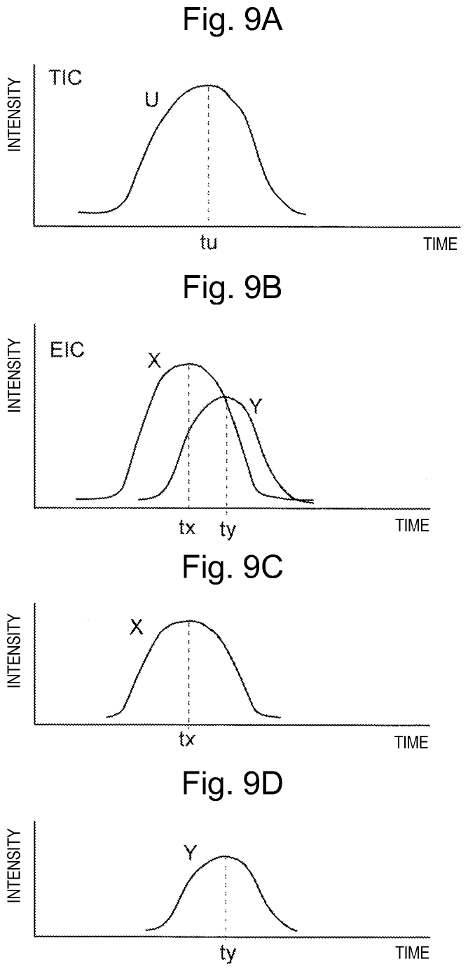

As an example, as shown in FIG. 9B, a case is considered in which two chromatographic peaks X and Y derived from different compounds having close retention times overlap and appear as one chromatographic peak U in TIC as shown in FIG. 9A. At a time tx of the peak top of the chromatographic peak X, a portion of the chromatographic peak Y overlaps, and thus mass peaks derived from two kinds of compounds respectively corresponding to the two chromatographic peaks X and Y are mixed in the mass spectrum obtained at the time tx. On the other hand, at a time ty of the peak top of the chromatographic peak Y, a portion of the chromatographic peak X overlaps, and thus mass peaks derived from two kinds of compounds respectively corresponding to the two chromatographic peaks X and Y are also mixed in the mass spectrum obtained at the time ty. In addition, as described in the example of FIGS. 6A to 6D, the chromatographic peak U on the TIC may overlap not only the chromatographic peaks derived from the compounds corresponding to the chromatographic peaks X and Y but also the chromatographic peaks derived from contaminants such as impurities contained in the mobile phase. Therefore, the mass spectrum separation processing unit 32 calculates mass spectrum information corresponding to the chromatographic peak X from mass spectrum data in which mass peaks derived from a plurality of compounds are mixed by any of the following methods.

<First method> As a result of the EIC extraction processing described above, the time tx of the peak top of the chromatographic peak X, is found. Therefore, the mass spectrum separation processing unit 32 collects all the mass peaks observed in the mass spectrum (centroid spectrum) obtained at the time tx, and regards them as mass spectrum information corresponding to the chromatographic peak X. However, as the mass peak here, for example, one of the following two definitions A and B is adopted.

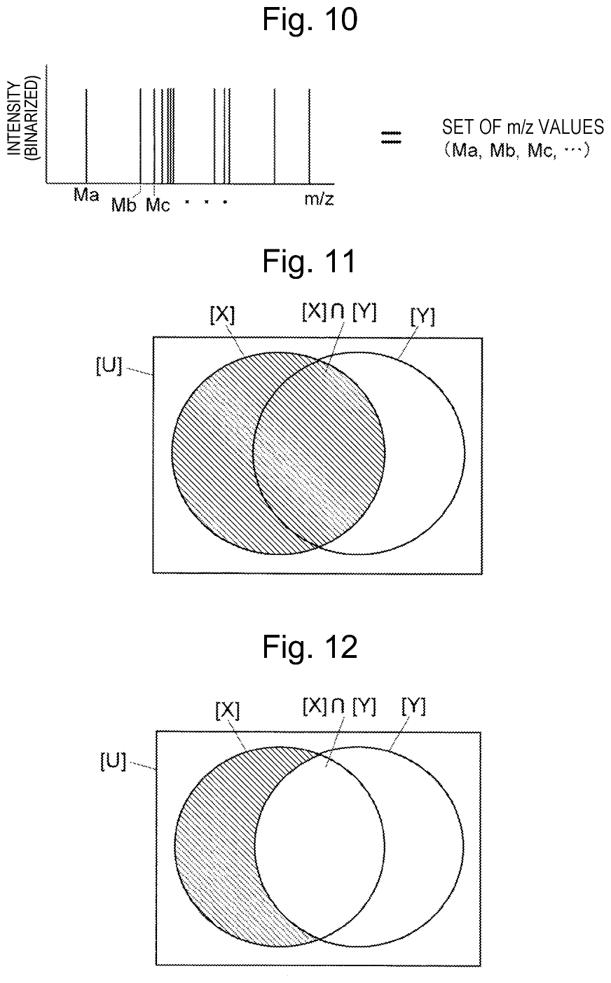

(Definition A) The intensity of the mass peak is substantially ignored, and only the m/z value at which the centroid peak exists is used as the peak information. In short, the intensity of each mass peak is binarized to “0” or “1”, and only the mass peak having the intensity of “1” is collected. Therefore, a certain mass spectrum can be represented by a set of m/z values {Ma, Mb, Mc, . . . } in which a mass peak exists. In addition, the mass spectrum is represented as a mass spectrum in a bar display in which the intensity at each m/z on the m/z axis is binary as illustrated in FIG. 10.

(Definition B) Each pair of m/z value and intensity of a mass peak observed in a mass spectrum at the time tx of the peak top of the chromatographic peak X, or a mass peak observed in an average mass spectrum of a plurality of mass spectra obtained in a predetermined time range (near the peak top) centered on the time tx of the peak top of the chromatographic peak X, is defined as peak information. Therefore, a certain mass spectrum can be represented by a set of pairs {(Ma, Ia), (Mb, Ib), (Mc, Ic), . . . } of m/z values and intensities at which a mass peak exists.

When Definition A is adopted in a first method, a mass spectrum (mass spectrum ignoring intensity information in the original mass spectrum) as shown in FIG. 10 obtained at the time tx of the peak top of the chromatographic peak X is a mass spectrum corresponding to the chromatographic peak X. On the other hand, when Definition B is adopted in the first method, the set of mass peaks given by Definition B is a mass spectrum directly corresponding to the chromatographic peak X.

The relationship between the mass peaks observed on the mass spectra at the time of peak tops of the chromatographic peaks X, Y, and U is shown in a Venn diagram in FIG. 11. [U], [X], and [Y] represent a set of mass peaks observed on a mass spectrum obtained at the time of peak tops of the chromatographic peaks U, X, and Y, respectively. Then, a portion indicated by hatching in FIG. 11, that is, [X] is mass spectrum information obtained by the first method, which is a set of mass peaks observed in the mass spectrum at the peak top of the chromatographic peak X. As illustrated, the mass spectrum information obtained by this first method includes a portion of the mass peak derived from the compound corresponding to the chromatographic peak Y, but does not include the mass peak derived from the compound corresponding only to the chromatographic peak U.

<Second method> The mass spectrum separation processing unit 32 subtracts a mass peak observed in the mass spectrum at the time ty of the peak top of the chromatographic peak Y from the set [X] of mass peaks obtained by the above-described first method, and sets the remaining mass peaks as mass spectrum information corresponding to the chromatographic peak X.

When Definition A is adopted in this second method, the intensity of each mass peak is not considered. Therefore, the mass spectrum formed in this case is a mass spectrum corresponding to a difference set between a set of mass peaks derived from the chromatographic peak X and a set of mass peaks derived from the chromatographic peak Y. That is, it is mass spectrum information corresponding to a portion indicated by hatching in the Venn diagram illustrated in FIG. 12.

On the other hand, when Definition B is adopted in the second method, the mass peak subtraction is defined by subtraction of intensity values between mass peaks having the same m/z value. However, this subtraction can be performed on the basis of the intensity value obtained by distributing the intensity of the mass peak at the corresponding m/z value on the mass spectrum at the time tx according to the intensity ratio between the chromatographic peak X and the chromatographic peak Y at the time tx. Therefore, in this case, unlike the case where Definition A is adopted, a mass peak indicating an intensity value estimated to be derived from the compound corresponding to the chromatographic peak X remains in a range indicated by [X]∩[Y] in the Venn diagram shown in FIG. 12.

<Third method> The mass spectrum separation processing unit 32 collects a mass peak observed in the mass spectrum at the time tx of the peak top of the chromatographic peak X and a mass peak observed in the mass spectrum at a time tu of the peak top of the chromatographic peak U, subtracts a mass peak observed in the mass spectrum at the time ty of the peak top of the chromatographic peak Y, and uses the remaining mass peaks as mass spectrum information corresponding to the chromatographic peak X.

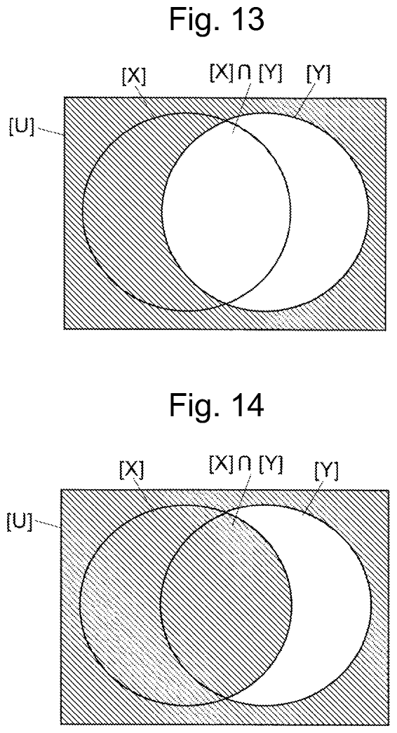

When Definition A is adopted in a third method, the mass spectrum information formed by this corresponds to a portion indicated by hatching in the Venn diagram illustrated in FIG. 13, that is, a complementary set of a set [Y] of mass peaks observed in the mass spectrum at the time ty of the peak top of the chromatographic peak Y. On the other hand, when Definition B is adopted in the third method, addition and subtraction of mass peaks can be defined by addition and subtraction of intensity values between mass peaks having the same m/z value as in the second method.

<Fourth method> The mass spectrum separation processing unit 32 adds a set [X]∩[Y] of mass peaks observed both in the mass spectrum at the time tx of the peak top of the chromatographic peak X and in the mass spectrum at the time ty of the peak top of the chromatographic peak Y to the complementary set of the set [Y] of mass peaks obtained by the third method, and uses this as mass spectrum information corresponding to the chromatographic peak X.

When Definition A is adopted in a fourth method, the mass spectrum information formed by this corresponds to a portion indicated by hatching in the Venn diagram illustrated in FIG. 14, that is, a complementary set of a set of mass peaks observed only in the mass spectrum at the time ty of the chromatographic peak Y.

On the other hand, when Definition B is adopted in the fourth method, addition and subtraction of mass peaks can be defined by addition and subtraction of intensity values between mass peaks having the same m/z value as in the second and the third methods.

The mass spectrum derived from the compound corresponding to the chromatographic peak X or the mass peak information in the mass spectrum can be obtained using any of the first to fourth methods. Similarly, a mass spectrum derived from a compound corresponding to the chromatographic peak Y overlapping the chromatographic peak X or mass peak information in the mass spectrum can be obtained. The mass spectrum display processing unit 34 displays the mass spectrum calculated by the mass spectrum separation processing unit 32 on the screen of the display unit 5.

It is preferable that which one of the above first to fourth methods is used and which one of Definitions A and B is used can be appropriately selected by the user. In addition, the method for calculating the mass spectrum corresponding to each chromatographic peak is not limited to the methods described above, and can be appropriately changed.

As described above, according to the LC-MS of the present embodiment, the EIC corresponding to the significant compound contained in the sample can be automatically and comprehensively extracted and presented to the user. In addition, at the same time, it is possible to automatically determine whether or not there is a compound that is eluted in a temporally overlapping manner, and which compound is overlapped, and to notify the user of the determination. Furthermore, mass spectra respectively corresponding to a plurality of compounds eluting in a temporally overlapping manner can also be presented to the user.

In the above embodiment, the present invention is applied to LC-MS, but it is obvious that the present invention can also be applied to GC-MS.

In addition, the above embodiment is merely an example of the present invention, and it is a matter of course that deformations, modifications, additions, and the like appropriately made within the scope of the gist of the present invention are included in the claims of the present application.

### Various Modes

A person skilled in the art can understand that the previously described illustrative embodiments are specific examples of the following modes of the present invention.
(Clause 1) One mode of the chromatograph mass spectrometer according to the present invention is a chromatograph mass spectrometer including a data processing unit configured to process data collected by chromatograph mass spectrometry, the data processing unit including:
a first peak detection unit configured to create a chromatogram reflecting signal intensity at a plurality of mass-to-charge ratios on a basis of the collected data and perform peak detection on the chromatogram;
an extracted ion chromatogram creation unit configured to create, for at least one of peaks detected by the first peak detection unit, an extracted ion chromatogram with respect to a mass-to-charge ratio of a centroid peak observed in a mass spectrum obtained in a time range of the at least one of peaks;
a second peak detection unit configured to perform peak detection on the extracted ion chromatogram created by the extracted ion chromatogram creation unit and obtain a retention time of a peak top of the detected peak;
a grouping unit configured to classify the peaks detected by the second peak detection unit into groups having substantially the same retention time of the peak top; and a selection unit configured to select one or more representative mass-to-charge ratios or one or more extracted ion chromatograms corresponding to representative mass-to-charge ratios for each group classified by the grouping unit.

(Clause 8) Further, one mode of the chromatograph mass spectrometry data processing method according to the present invention is a chromatograph mass spectrometry data processing method for processing data collected by chromatograph mass spectrometry, the method including:
a first peak detection step of creating a chromatogram reflecting signal intensity at a plurality of mass-to-charge ratios on a basis of the collected data and perform peak detection on the chromatogram;
an extracted ion chromatogram creation step of creating, for at least one of peaks detected in the first peak detection step, an extracted ion chromatogram with respect to a mass-to-charge ratio of a centroid peak observed in a mass spectrum obtained in a time range of the at least one of peaks;
a second peak detection step of performing peak detection on the extracted ion chromatogram created in the extracted ion chromatogram creation step, and obtaining a retention time of a peak top of the detected peak;
a grouping step of classifying the peaks detected in the second peak detection step into groups having substantially the same retention time of the peak top; and a selection step of selecting one or more representative mass-to-charge ratios or one or more extracted ion chromatograms corresponding to representative mass-to-charge ratios for each group classified in the grouping step.

The chromatograph mass spectrometer according to Clause 1 is typically LC-MS or GC-MS. In that case, as the MS unit, various types of mass spectrometers such as a single quadrupole mass spectrometer, a triple quadrupole mass spectrometer, a quadrupole-time-of-flight mass spectrometer, and an ion trap mass spectrometer can be used.

(Clause 2) In the chromatograph mass spectrometer according to Clause 1, the chromatogram reflecting the signal intensity at the plurality of mass-to-charge ratios may be any of TIC, BPC, and MIC.

According to the chromatograph mass spectrometer according to Clause 1 and Clause 2, and the chromatograph mass spectrometry data processing method according to Clause 8, it is possible to extract EICs corresponding to target compounds and unknown impurities and contaminants in a sample without omission from an enormous amount of mass spectrum data and chromatogram data collected by chromatograph mass spectrometry without complicated work and operation by a user (operator). By automatically performing such processing, the burden on the operator can be reduced. In addition, since such processing does not depend on the skill, experience, or the like of the operator, variations in processing results can be suppressed. In addition, the time required for the operation can be shortened, and the compound can be efficiently analyzed.

(Clause 3) The chromatograph mass spectrometer according to Clause 1 or 2 may further include a co-elution determination unit configured to determine co-elution depending on whether or not there are a plurality of groups having a common time range.

According to the chromatograph mass spectrometer according to Clause 3, the presence or absence of co-elution and the co-eluted compound can be easily and accurately determined.

(Clause 4) The chromatograph mass spectrometer according to any one of Clauses 1 to 3 may further include a peak selection unit configured to exclude a peak whose peak shape does not satisfy a predetermined reference with respect to a peak detected by the first peak detection unit, in which a peak remaining after selection by the peak selection unit may be subjected to processing by the extracted ion chromatogram creation unit.

In the chromatograph mass spectrometer according to Clause 4, a noise peak derived from the mobile phase or the like is removed in the peak selection unit. This makes it possible to more accurately extract the EIC corresponding to the compound present in the sample.

(Clause 5) In the chromatograph mass spectrometer according to any one of Clauses 1 to 4, the selection unit may be configured to select one or more extracted ion chromatograms corresponding to representative mass-to-charge ratios for each group, and the chromatograph mass spectrometer may further include a display processing unit configured to display the extracted ion chromatogram or chromatograms for each group selected by the selection unit on a display unit.

The display processing unit may display a plurality of EICs on the display unit at the same time, for example, by overlapping or arranging the EICs, or may display the EICs switchably according to an instruction.

According to the chromatograph mass spectrometer according to Clause 5, EIC or EICs corresponding to significant compound or compounds contained in the sample can be presented to the user.

(Clause 6) In the chromatograph mass spectrometer according to Clause 5, the display processing unit may extract and display a waveform in a peak range from a start point to an end point of a peak appearing in an extracted ion chromatogram or in a predetermined time range including the peak range.

According to the chromatograph mass spectrometer according to Clause 6, it is possible to present only a significant peak waveform around a retention time at which the significant compound contained in the sample appears to the user.

(Clause 7) In the chromatograph mass spectrometer according to any one of Clauses 1 to 6, the data processing unit may further include a mass spectrum separation processing unit configured to extract, from the collected data, information on a mass peak corresponding to the peak using information on a peak observed in the extracted ion chromatogram selected by the selection unit, and create a mass spectrum.

According to the chromatograph mass spectrometer according to Clause 7, not only an EIC or EICs for each compound contained in the sample can be obtained, but also mass spectrum for each compound can be obtained. As a result, for example, the type of the compound can be confirmed and the structure can be estimated using the mass spectrum.

### REFERENCE SIGNS LIST

1 . . . LC Unit
10 . . . Mobile Phase Container
11 . . . Liquid Feeding Pump
12 . . . Injector
13 . . . Column
2 . . . MS Unit
20 . . . Ionization Unit
21, 22 . . . Ion Guide
23 . . . Quadrupole Mass Filter
24 . . . Detector
3 . . . Data Processing Unit
30 . . . Data Storage Unit
31 . . . EIC Extraction Processing Unit
310 . . . TIC Creation Unit
311 . . . TIC Peak Detection Unit
312 . . . TIC Peak Selection Unit
313 . . . Provisional EIC Creation Unit
314 . . . EIC Peak Detection Unit
315 . . . EIC Grouping Unit
316 . . . EIC Selection Unit
32 . . . Mass Spectrum Separation Processing Unit
33 . . . EIC Display Processing Unit
34 . . . Mass Spectrum Display Processing Unit
35 . . . Co-elution Determination Unit
4 . . . Input Unit
5 . . . Display Unit

1. A chromatograph mass spectrometer comprising a data processing unit configured to process data collected by chromatograph mass spectrometry, the data processing unit including:
a first peak detection unit configured to create a chromatogram reflecting signal intensity at a plurality of mass-to-charge ratios on a basis of the collected data and perform peak detection on the chromatogram;
an extracted ion chromatogram creation unit configured to create, for at least one of peaks detected by the first peak detection unit, an extracted ion chromatogram with respect to a mass-to-charge ratio of a centroid peak observed in a mass spectrum obtained in a time range of the at least one of peaks;
a second peak detection unit configured to perform peak detection on the extracted ion chromatogram created by the extracted ion chromatogram creation unit and obtain a retention time of a peak top of the detected peak;
a grouping unit configured to classify the peaks detected by the second peak detection unit into groups having substantially the same retention time of the peak top; and
a selection unit configured to select one or more representative mass-to-charge ratios or one or more extracted ion chromatograms corresponding to representative mass-to-charge ratio for each group classified by the grouping unit.

2. The chromatograph mass spectrometer according to claim 1, wherein the chromatogram reflecting the signal intensity at the plurality of mass-to-charge ratios is any of a total ion chromatogram, a base peak chromatogram, and a multi ion chromatogram.

3. The chromatograph mass spectrometer according to claim 1 further includes a co-elution determination unit configured to determine co-elution depending on whether or not there are a plurality of groups having a common time range.

4. The chromatograph mass spectrometer according to claim 1 further includes a peak selection unit configured to exclude a peak whose peak shape does not satisfy a predetermined reference with respect to a peak detected by the first peak detection unit, wherein a peak remaining after selection by the peak selection unit is subjected to processing by the extracted ion chromatogram creation unit.

5. The chromatograph mass spectrometer according to claim 1, wherein the selection unit is configured to select one or more extracted ion chromatograms corresponding to representative mass-to-charge ratios for each group, and the chromatograph mass spectrometer further includes a display processing unit configured to display the extracted ion chromatogram or chromatograms for each group selected by the selection unit on a display unit.

6. The chromatograph mass spectrometer according to claim 5, wherein the display processing unit is configured to extract and display a waveform in a peak range from a start point to an end point of a peak appearing in an extracted ion chromatogram or in a predetermined time range including the peak range.

7. The chromatograph mass spectrometer according to claim 1, wherein the data processing unit further includes a mass spectrum separation processing unit configured to extract, from the collected data, information on a mass peak corresponding to the peak using information on a peak observed in the extracted ion chromatogram selected by the selection unit, and create a mass spectrum.

8. A chromatograph mass spectrometry data processing method for processing data collected by chromatograph mass spectrometry, the method comprising:
a first peak detection step of creating a chromatogram reflecting signal intensity at a plurality of mass-to-charge ratios on a basis of the collected data and perform peak detection on the chromatogram;
an extracted ion chromatogram creation step of creating, for at least one of peaks detected in the first peak detection step, an extracted ion chromatogram with respect to a mass-to-charge ratio of a centroid peak observed in a mass spectrum obtained in a time range of the at least one of peaks;
a second peak detection step of performing peak detection on the extracted ion chromatogram created in the extracted ion chromatogram creation step, and obtaining a retention time of a peak top of the detected peak;
a grouping step of classifying the peaks detected in the second peak detection step into groups having substantially the same retention time of the peak top; and
a selection step of selecting one or more representative mass-to-charge ratios or one or more extracted ion chromatograms corresponding to representative mass-to-charge ratios for each group classified in the grouping step.
